(19) United States
(12) Patent Application Publication
(10) Pub. No.: US 2010/0145736 A1
(43) Pub. Date: Jun. 10, 2010

(54) HEALTHCARE INCENTIVE SYSTEM AND METHOD

(76) Inventor: Michael Rohwer, Salem, OR (US)

Correspondence Address: STOEL RIVES LLP - PDX, 900 SW FIFTH AVENUE, SUITE 2600, PORTLAND, OR, 97204-1268, US

(21) Appl. No.: 12/628,888

(22) Filed: Dec. 1, 2009

Related U.S. Application Data
(60) Provisional application No. 61/119,685, filed on Dec. 3, 2008.

(51) Int. Cl. G06Q 40/00; G06Q 30/00

(52) U.S. Cl. 705/4

(57) ABSTRACT

A method for rewarding providers who are parts of virtual teams may permit a payer to establish practice goals, clinical goals, cost containment goals, or other goals by rewarding outcomes deemed to be beneficial by the payer, providers, or both. Providers may participate in one or more member management objects, which may be software that define provider and patient goals and a set of rewards for achieving the provider and patient goals. Subscribing to a member management object may reward providers with bonus payments when a provider goal is met, which may be met by achieving patient goals. The patient goals may be defined in the member management object, and may relate to medical practices, including procedures performed, procedures not performed, clinical results, lab and other test results, diagnoses, referrals, and cost objectives. By subscribing to member management objects, providers may become parts of virtual teams of providers, each virtual team rendering services for one patient. Provider team members may be able to view the other virtual team members, the past services rendered by the other virtual team members, and the results of the services provided by the other virtual team members.

### PRIORITY INFORMATION

This application claims the benefit under 35 U.S.C. §119(e) of U.S. Provisional Patent Application No. 61/119,685, filed Dec. 3, 2008, which is fully incorporated by reference herein.

### BACKGROUND

The present invention relates to incentive systems and methods. Patients typically contract with an insurance company (i.e., a payer), and pay a premium in return for the insurance company paying for all or a portion of contractually defined healthcare services should the patient require such services. The insurance company also contracts with healthcare providers to provide services at contractually agreed prices. When patients visit healthcare providers, such as a primary care physician, a nurse practitioner, a nutritionist, a medical specialist, etc., a substantial portion of the cost of visiting the healthcare provider may be paid by the payer. Typical payer plans require the healthcare provider to submit payment claims to the payer and the payer determines whether the claim should be paid or not. Payments may be made on a fee for service basis, that is, a fee directly tied to the service performed, or on a capitation basis, that is, a single payment for a specified time period regardless of the number of services performed.

The present inventor has recognized that many problems persist with existing payer systems for paying for healthcare services. These problems include failure to promote quality services, failure to recognize cost reducing measures, and isolating providers from one another. Current payer systems may not account for the value of clinical quality, having a patient centered focus, or for efficiency. Current payer systems also may not reward preventative healthcare services that reduce or eliminate additional services a patient needs, and may limit or prevent coordination and information flow between various providers who treat a patient.

The present inventor has also recognized that current pay for performance systems have problems. For example, current pay for performance systems may use a limited set of clinical parameters to assess quality, which may not facilitate care coordination, especially when performance payments are grafted onto current payment systems. Existing pay for performance systems may provide incentives for only a few specific areas of treating a disease or medical condition, and may limit performance payments to a single provider. By concentrating on only a few areas of a healthcare aspect such as a disease or medical condition, other, potentially more important elements of care for that healthcare aspect may be neglected. Other existing pay for performance systems may use a team approach, for example, the Prometheus system, but may require healthcare providers to form contractually bound teams to provide healthcare for patients, thus resulting in inflexible, set teams. Another concern is that healthcare providers rewarded for only limited clinical parameters or specific areas of a disease or medical condition may have a strong incentive to render services primarily for patients with conditions likely to result in treatments that satisfy the limited clinical parameters or specific areas of a disease or medical condition, and not take on other patients.

Current payer systems, including pay for performance systems, may thus make it difficult for payers to provide adequate incentives for effective results, and difficult for payers and providers to assess the effectiveness and efficiency of a treatment plan or to share information regarding a patient's treatment.

### SUMMARY

The present inventor has recognized a need for incentive systems and methods that may address the above problems with existing healthcare payment systems and methods; reward providers for desirable clinical and/or cost results; provide providers with access to information regarding the services rendered for a patient by other providers, including the results of those services; facilitate referrals for a patient; provide access to information regarding providers for a patient to view provider information; and/or address other healthcare aspects.

In accordance with preferred embodiments, an incentive system may be team oriented and may include centralized information. The centralized information may be used to process payment requests submitted to an existing payer payment program and to create unbounded virtual teams of providers, each team centered around one patient. Throughout the disclosure, the terms “virtual team” and “team” include unbounded virtual teams, unless otherwise indicated. Providers may be rewarded for their contributions to each team of which the provider is a member. Providers may also be granted information access to information related to patients and/or other providers. Incentive method or system embodiments may provide solutions to the above mentioned problems with current payment systems and pay for performance systems, or may assist with ensuring quality of care, fostering the patient/provider relationship, offer voluntary provider participation, provide fair and equitable incentives, or may provide other suitable benefits or advantages.

Additional aspects and advantages will be apparent from the following detailed description of preferred embodiments, which proceeds with reference to the accompanying drawings.

### BRIEF DESCRIPTION OF THE DRAWINGS

FIG. 1 is a prior art information flow diagram.

FIG. 2 is an information flow diagram for a preferred embodiment.

FIG. 3 is a schematic diagram of providers and patients interacting with a preferred embodiment.

FIG. 4 is a chart depicting virtual team formation for a preferred embodiment.

FIG. 5 is a schematic diagram for a preferred embodiment.

FIG. 6 is a schematic of an exemplary payment request database for a preferred embodiment.

FIG. 7 is a schematic of an exemplary encounter database for a preferred embodiment.

FIG. 8 is a schematic of an exemplary patient database for a preferred embodiment.

FIG. 9 is a schematic of an exemplary cost database for a preferred embodiment.

FIG. 10 is a schematic of an exemplary provider database for a preferred embodiment.

FIG. 11 is a schematic of an exemplary clinical database for a preferred embodiment.

FIG. 12 is a flow diagram for pre-qualification determination according to a preferred embodiment.

FIG. 13 is a schematic for an exemplary member management object according to a preferred embodiment.

FIG. 14 is a schematic that illustrates a computer system 1400 upon which an embodiment may be implemented.

### DETAILED DESCRIPTION OF PREFERRED EMBODIMENTS

An incentive system in accordance with one embodiment may include a computer program that is run after a payment request from a provider is processed. Providers may voluntarily participate with the incentive system, for example, by registering as a user of the computer program. Preferably, a provider's base pay is not affected by whether the provider is involved with the incentive system or not. The incentive system software may include a main program, subprograms, and/or databases. The incentive system software may run on a single computer, including the computer that runs the payment system, or the incentive system may be distributed over computers that are networked to, or otherwise suitably communicate with, one another. Both the main program and/or the subprogram(s) may make database calls as needed to manipulate data.

An incentive system may provide overall programming flow and incentive system software may interact with other software such as a payer's payment software. The incentive system software may include computer code and/or computer hardware that makes database calls as needed to obtain information and may call or otherwise suitably exchange information with other software. A provider may interact with the incentive system software to participate in specific healthcare programs.

Healthcare programs preferably provide the specific details, for example, through medical codes including procedure and diagnostic codes, regarding what actions are to be taken and what actions are to be refrained from being taken with respect to a specific disease, medical condition, costs, or other suitable healthcare aspect. Healthcare programs may contain taxonomy codes relating to what types of providers may participate in a particular healthcare program and/or what roles providers may have. Healthcare programs may also be used to create and track provider team rosters, where each team includes providers who render services for a patient. For example, a healthcare program may include software and/or hardware, or a combination of the two, that makes database calls to associate a patient's unique identifier with all of the providers who rendered services defined in the healthcare program within a set time period.

Healthcare programs may also be used to define patient goals and provider goals. Patient goals may relate to care for a particular patient, and provider goals may relate to a provider's overall performance related to a medical condition, or other suitable healthcare aspect. Whether patient goals and provider goals are achieved may be determined when a payment request is transmitted to the incentive system. A determination may be made that a reward is associated with a payment request if a provider achieves the provider goals at the time the payment request is processed.

The incentive system may also include databases to store information manipulated by the software and/or hardware, or combination of software and hardware. An encounter database may store data related to patient identifiers, provider identifiers, and clinical data such as what happened during a patient's visit to a provider, for example, by using medical codes such as procedure and diagnostic codes. A cost database may be provided, and may contain information similar to the encounter database plus cost data. Alternatively, the cost database may be incorporated into the encounter database. A clinical database may store clinical data related to each patient, for example an Electronic Health Record for each patient, or data entered in an Internet form by a provider after a patient's visit. Alternatively, a clinical database may be a Community Health Information Exchange.

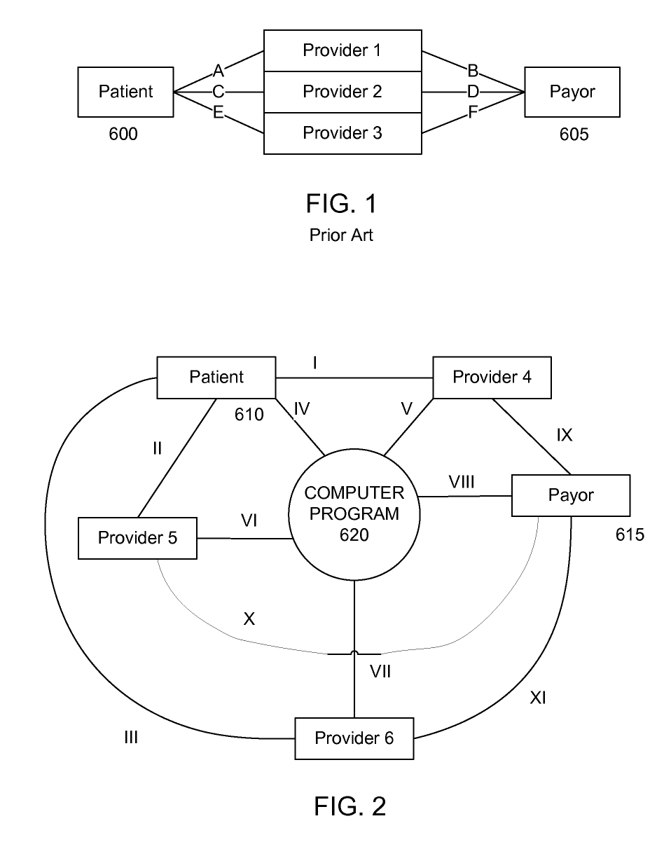

Referring to FIG. 1, a prior art information flow schematic for a payer payment system is illustrated. Typically, the Patient 600 sees Provider 1 who may diagnose a medical condition the Patient 600 has and/or render services related to such a medical condition. Line A represents the information flow between the Patient 600 and Provider 1, for example, from face-to-face communication. Provider 1 typically submits a payment request to the Payer 605, represented by line B. Thus Provider 1 communicates directly with both the Patient 600 and the Payer 605.

The Patient 600 may see another provider, such as Provider 2, to further treat the same or related medical conditions diagnosed by Provider 1. Provider 1 and Provider 2 may or may not communicate with one another, either before or during treatment for the Patient 600. If Provider 2 wants information about the services Provider 1 renders and the results of those services, Provider 2 may communicate with the Patient 600, line C. A similar information flow may result should the Patient 600 see Provider 3. Therefore, typical payer systems may keep providers isolated from one another, and may make it difficult for a provider to obtain the appropriate information about the patient, such as information regarding other services received by the patient for the same medical conditions.

If Provider 1 and Provider 2 do communicate with one another regarding treatment for the Patient 600, it may be because Provider 1 and Provider 2 are contractually bound to one another, for example, by a contractual agreement to be part of a team to treat a patient, such as used in the Prometheus system, and/or are employed by the same medical practice or group. Such arrangements tend to limit which providers may render services for the patient because of the pre-existing contractual, employment, or other suitable arrangement in place before a provider sees a patient.

FIG. 2 illustrates an information flow schematic for a preferred configuration of an incentive system. The configuration uses a web like information flow facilitated by a centralized computer program 620, that is, a computer program 620 accessible to Provider 4, Provider 5, Provider 6, the Payer 615, and/or the Patient 610.

One function of the computer program 620 may be to facilitate information flow between Patient 610 and the providers rendering services for Patient 610. Patient 610 may communicate with Provider 4, Provider 5, and Provider 6 over lines I, II, and III, respectively. Lines I, II, and III may include face to face communications, telephone communication, electronic communication, written communication, or other suitable manner for exchanging information. Provider 4, Provider 5, and Provider 6 may communicate with one another via the computer program 620 and lines V, VI, and VII, respectively. Lines V, VI, and VII may include data transmission lines such as cables, wires, and fiber optics; wireless transmission such as radio, light wave, microwave; removable memory devices; or other suitable media for transmitting electronic data between computers.

Provider 4, Provider 5, and Provider 6 may each render services for the Patient 2 related to a healthcare aspect such as a medical condition. Services may be related to a healthcare aspect by virtue of definition in a healthcare program, or may otherwise suitably relate to a healthcare aspect. Provider 4, Provider 5, and Provider 6 may submit payment requests to Payer 615 over lines IX, X, and Xl. Lines IX, X, and XI may include the same or similar lines as lines V, VI, and VII; written communication; or other suitable manner for sending and receiving billing information. Payer 615 may communicate with the computer program 620 over line VIII, for example, to determine whether Provider 4, Provider 5, or Provider 6 is eligible for a reward when a payment request is submitted, as described below. Line VIII is preferably a medium suitable for exchanging information between computers, or internally within a computer.

The computer program 620 may be programmed to automatically make Provider 4, Provider 5, and/or Provider 6 part of an unbounded virtual team where each member of the team renders services and/or makes referrals for Patient 610. Preferably, an unbounded virtual team is created or modified in real-time, or near real-time, when a payment request is transferred to the computer program 620 through Payer 615, described below. A virtual team may be unbounded when the providers do not have a pre-existing arrangement with one another before seeing a patient; when some or all of the providers do have a pre-existing arrangement with one another before seeing a patient, but the arrangement does not specifically relate to the patient; and/or when a virtual team does not have a pre-defined number of providers or pre-selected type of providers before services are rendered for a patient. For example, but not limited to, an unbounded virtual team may be created with providers who are not contractually obligated to one another to render services for a patient or a group of patients, or who are not working for or employed by the same organization.

Preferably, when Providers 4-6 are virtual teammates, the computer program 620, or a person administering the computer program 620, may grant information access to the medical records for Patient 2. Preferably, the information access grant is limited to the healthcare aspect related to the services rendered by Providers 4-6. Information access may be granted by setting Provider 4-6's permissions in the computer program 620 to an appropriate level, by issuing passwords or logon information, or by other suitable means.

Through the information access to the medical records and/or by communicating with the computer program 620 over lines V, VI, and VII, Provider 4, Provider 5, and Provider 6, respectively, may each indirectly communicate with one another and/or view the notes, services rendered, tests, test results, referrals, clinical results, and/or other suitable information each provider communicates to the computer program 620 related to a healthcare aspect. Thus, Provider 4, Provider 5, and Provider 6 do not need to have a pre-existing arrangement to easily share information concerning Patient 610 and the treatment Patient 610 receives.

When a provider becomes involved with the incentive system, for example by registering with the computer program 620, the computer program 620 or administrator may grant a provider information access. For example, a provider may access a provider pool which may include a database containing records related to providers registered with the computer program 620. Information access to the provider pool may be granted in a manner similar to how information access is granted for medical records. Granting information access to the provider pool may permit providers and/or patients to review providers' performance, virtual team success rates, or other suitable information.

For example, a provider may submit an information request for information about which providers serve which provider roles. The computer program 620 may respond with a list of providers that may be an alphabetical list by provider name and giving the role each provider serves and whether the provider has achieved a provider goal; may be categorized by role and include a list of each provider serving a particular role, including whether each provider has achieved a provider goal; may be a list of providers ranked by the number of successful virtual teams, discussed below, each provider is a member of; or other suitable manner for supplying provider information. Alternatively, a provider may submit an information request for information about the composition of successful virtual teams related to a healthcare aspect. The computer program 620 may respond with information regarding each virtual team including which particular providers are on each virtual team, and the composition of each virtual team, in other words, what provider roles are included in each team. The information returned may also include whether each virtual team has achieved the patient goals related to the healthcare aspect, discussed below.

In another preferred embodiment, Patient 610 may also communicate with the computer program 620 over line IV. When Patient 610 communicates with the computer program 620, Patient 610 may be able to research Provider 4, Provider 5, and/or Provider 6 before visiting any of the providers, may be able to send non-emergency questions to Provider 4, Provider 5, and/or Provider 6, or take other suitable action.

In alternate embodiments, healthcare programs for the same or similar healthcare aspect, and the results obtained from such healthcare programs, may be compared against one another. Comparing similar healthcare programs and the results obtained from such healthcare programs may permit individual healthcare programs to be modified to obtain better results.

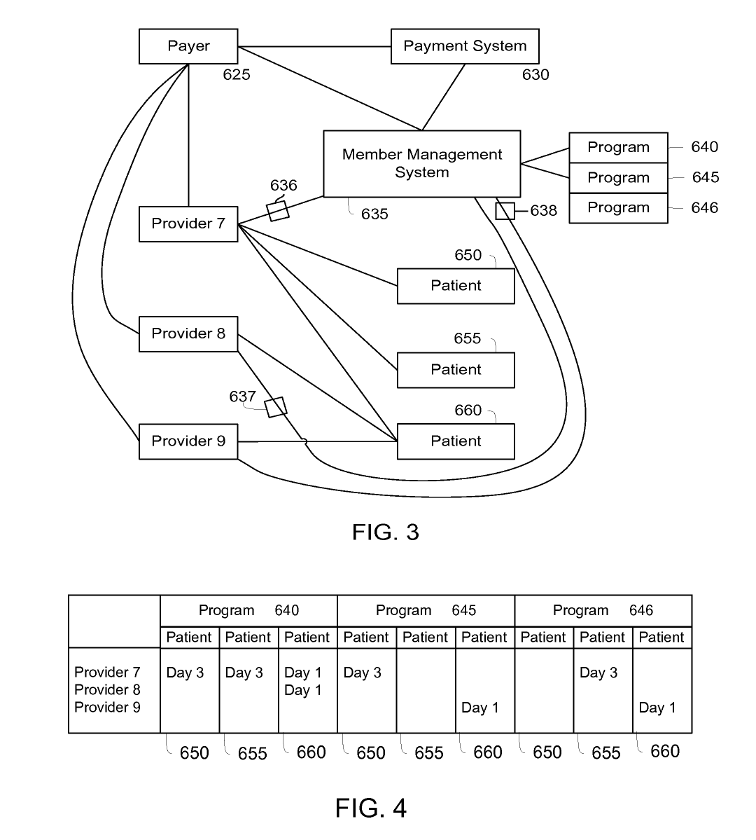

Referring to FIG. 3, a schematic for a preferred incentive system is illustrated. FIG. 3 illustrates a preferred virtual team oriented incentive system, in which unbounded virtual teams of providers are created upon receiving payment requests related to the providers rendering services for patients, and where the services are defined in the healthcare programs of the incentive system.

Payer 625 may be an insurance company that provides health insurance for Patient 3, Patient 4, and Patient 660. Alternately, Payer 625 may be a governmental entity, employer, or other suitable payer.

Provider 7, Provider 8, and Provider 9 may be healthcare providers who may or may not have contractual arrangements to provide healthcare services for the members (Patient 650, Patient 655, and Patient 660) of Payer 625's health insurance program in exchange for payment from Payer 625. While the providers preferably have a contractual relationship with the payer, the providers preferably do not have a pre-existing arrangement with one another, and do not necessarily work for the same employer organization. However, in some instances, the providers may have contractual obligations to one another, and may work for, or be employed by, the same organization. An unbounded virtual team therefore does not require that the providers have a pre-existing arrangement with one another, but does not preclude the providers from having a pre-existing arrangement with one another. If there is a pre-existing arrangement between providers, the pre-existing arrangement is preferably not accounted for when an unbounded virtual team is formed.

For example, Provider 7 may be a solo healthcare provider, provider 8 may work for a hospital as a healthcare contractor, and Provider 9 may be an employee, partner, or member of a private medical group. Providers 7-9 may become unbounded virtual teammates after seeing a patient for a related healthcare aspect. Alternately, Provider 7 and Provider 9 may both be employees, partners, or members of the same private medical group, and Provider 8 may work for a public hospital, or alternatively, Provider 8 may also be an employee, partner, or member of the same private medical group. Providers 7-9 may become unbounded virtual teammates after seeing a patient for a related healthcare aspect. Providers 7-9 are also free to remove themselves from the incentive system, and therefore from virtual teams, at any desired time.

Payer 625 may operate a payment system 630 to adjudicate payment requests from Provider 7, Provider 8, and Provider 9. Payer 625 may also operate an incentive system in the form of a member management system 635, which may be computer software, hardware, or a combination of computer hardware and software, bearing instructions for operating healthcare programs 640, 645. Healthcare programs 640, 645 may provide incentives for Provider 7, Provider 8, and Provider 9, may provide incentives for Patient 650, Patient 655, and Patient 660, may permit patient information to be accessed by providers, and/or may permit provider information to be accessed by patients, as further described below.

In accordance with preferred embodiments, a software based incentive program may be used in conjunction with an existing payment system to define medical conditions, diseases, costs, or other suitable healthcare aspects a payer rewards. The incentive program may define actions to be taken and/or results to obtain for each healthcare aspect, and may be created by a payer, by providers, or by both. Preferably, providers voluntarily participate with the incentive program, and are free to stop participating at any time. The incentive program may automatically build virtual teams of providers for each patient treated for a healthcare aspect defined in the incentive program. Construction of a virtual team may be triggered by a provider submitting a payment request to a payer, or by another suitable action, and virtual teams may be simple database information linking providers to a patient. Members of a virtual team may be permitted to view or access the data related to the patient for whom the team was created.

The payer, providers, or both, may use the incentive system to define what results must occur with respect to each healthcare aspect to qualify a provider for a reward. The defined results may be provider specific, that is, achieved by the actions of a single provider, may be team oriented, that is, achieved by the actions of a virtual team, or may be a combination of both provider specific results and virtual team results. Preferred incentive systems may thus provide incentives and/or information for providers to achieve defined results and/or other suitable results.

The following hypothetical situations track Payer 625 implementing a preferred embodiment of an incentive system, and are given to provide an example how an embodiment may be implemented and operated. Processing details are not discussed in the following hypothetical situations, but are discussed below for alternate preferred embodiments.

Payer 625 enters contracts with Provider 7, Provider 8, and Provider 9 establishing payments by Payer 625 for healthcare services, and how much Payer 625 will pay for each healthcare service. Payer 625 operates a payment system 630, such as computer software, to determine whether provider payment requests from Provider 7, Provider 8, and Provider 9 meet the contractual criteria for payment. Payer 625 may add a member management system 635 as a compliment to the payment system 630 to reduce costs, increase transparency between Provider 7, Provider 8, and Provider 9, increase clinical effectiveness, and/or achieve alternate, suitable results. The member management system 635 is preferably computer software that runs independently from the payment system 630. The member management system 635 may run on the same computer that runs the payment system 630, or the member management system 635 may run on a separate computer that communicates with the computer that runs the payment system 630.

Preferably, registering with the member management system 635 is a voluntary option for Provider 7, Provider 8, and Provider 9, and they may participate in the member management system 635 and stop participating in the member management system 635 whenever and as often as they like.

Using a computer, Provider 7 may use a registration subsystem to directly or indirectly access the member management system 635 and proceed through registration. For example, registration may be accomplished using a registration subsystem such as a computer 636 connected to the Internet. Alternatively, registration may be accomplished using a computer 637 networked to the computer 638 running the member management system 635, or by using the computer 638 running the member management system 635. A registration subsystem may include hand-held devices or other suitable electronics that communicate with the member management system 635.

Provider 7 may supply information about Provider 7, such as healthcare field, contact information, and/or other suitable information. The member management system 635 may assign Provider 7 a role value (preferably used to adjust bonus payments, described in more detail below), a taxonomy code (if not provided by Provider 7) and may prompt Provider 7 to participate in one or more healthcare programs 640, 645.

Healthcare programs 640, 645, generally, each relate to a healthcare aspect and define a set of criteria, such as actions to be taken or avoided, and desired results to obtain. Preferably, the criteria should be achieved to qualify a provider and/or patient for a reward. For example, a healthcare program may relate to reducing costs, and may specify as the criteria to qualify a provider for a reward that for each patient a provider sees, the patient must visit a hospital emergency room no more than three times over the course of a year. Another healthcare program may relate to increasing the overall health of the members of the insurance program, and may specify as the criteria to qualify a provider for a reward that for each patient who smokes the provider sees, the patient must stop smoking within a year. Such a healthcare program may also reward patients who stop smoking within a year, and/or provide a reward for each year the patient refrains from smoking, may reward patients for using primary care physicians or clinics instead of hospital emergency rooms, or may reward other suitable patient actions. Other healthcare programs may relate to specific diseases or medical conditions, and may specify as the criteria to qualify a provider for a reward that certain tests or procedures are performed, or that certain test or clinical results are obtained. The range and scope of healthcare programs may include any suitable aspect of healthcare and may be designed to increase the effectiveness of treatment, reduce costs, increase efficiency, share information, or to obtain other suitable results.

Preferably, the healthcare programs 640, 645 may be created by Payer 625, Provider 7, Provider 8, and/or Provider 9, individually or in any combination.

Provider 7 may participate in one or more healthcare programs in the member management system 635. When Provider 7 registers as a user of the member management system 635 and specifies to participate in one or more healthcare programs 640, 645, a record for Provider 7 is preferably created in a database. The record may contain the information supplied by Provider 7, the role value and/or taxonomy code or role assigned to Provider 7 by the member management system 635, or supplied by Provider 7, and the healthcare programs 640 and/or 645 Provider 7 selected. Providers 8 and 9 may register with the member management system 635 in a similar manner, and may participate in the same, or different, healthcare programs 640, 645 as Provider 7.

Healthcare programs including a comprehensive set of clinical, or other, parameters may be created. For example, if Provider 7 is a doctor and Provider 8 is a registered nurse, and they both specialize in pulmonology, they may participate in the same healthcare programs 640, 645, but have different role values and taxonomy codes, or roles, and have different criteria to achieve based on their job description and qualifications. By creating virtual teams centered around each patient (described below), the providers and/or the payer may ensure there are providers to address each of the parameters set forth in a healthcare program for each patient. If Provider 9 is also a doctor and specializes in cardiothoracic surgery, Provider 9 may participate in completely different healthcare programs, or may participate in some, or all, of the same healthcare programs as Provider 7 and Provider 8.

Once Providers 7-9 are participating in healthcare programs 640 and/or 645 associated with the member management system 635, they may be eligible for rewards depending on the services rendered for Patients 650, 655, 660. Preferred embodiments may account for what is done for a patient within the scope of a program, when the services are rendered, and/or the results obtained for the patient as well as similar services rendered and/or results obtained for other patients within the scope of a program.

The following hypothetical examples take place after Providers 7-9 register with the member management system 635. Provider 7 participates in healthcare program 640 and healthcare program 645, Provider 8 participates in healthcare program 640, and Provider 9 participates in healthcare program 645. Healthcare program 640 relates to diagnosing pulmonary embolism and treatment, and healthcare program 645 relates to surgical management of acute pulmonary embolism. Provider 7 is a doctor and Provider 8 is a registered nurse both trained in internal medicine and specializing in pulmonology. Provider 9 is a surgeon who specializes in cardiothoracic surgery. Day 1 is the first day after Providers 7-9 register with the member management system 635 and participate in healthcare program 640 and/or 645. For clarity, the provider pool in the hypothetical examples is described containing Providers 7-9, but any number of providers may participate in healthcare program 640 and/or 645 and become a member of the provider pool.

Referring to FIGS. 3 and 4, at the beginning of Day 1, the member management system 635 may grant Providers 7-9 information access to the provider pool and a provider may be able to access the member management system 635 to obtain information about the other providers in the provider pool. For example, Provider 7 may request information regarding other providers who could give a second opinion for Patient 660, and receive information, such as roles for example, indicating that Provider 9 could provide a second opinion. The received information could also include additional details regarding Provider 9, such as practice information and/or virtual team performance data, including provider and/or patient goal achievements.

On day 1, Patient 650 visits Provider 7 who orders a D-dimer concentration blood test after listening to Patient 650's symptoms. Provider 7 submits a payment request to Payer 625 after the visit. Payer 625 processes the payment request through the payment system 630, determines that the office visit and blood test should be paid for, then passes the payment request to the member management system 635. The member management system 635 verifies that Provider 7 participates in healthcare program 640 and healthcare program 645, then checks the payment request against qualifications for healthcare program 640 and healthcare program 645. For the hypothetical, the blood test does not qualify for either healthcare program 640 or healthcare program 645 so the member management system 635 takes no further action and no reward is earned by Provider 7 for the visit. Alternately, Provider 7 may be added to an unbounded virtual team for Patient 650, described below, even though the rendered services do not qualify for healthcare program 640 or healthcare program 645. For example, Provider 7 may be added to a healthcare program 640 unbounded virtual team for Patient 650 if the services rendered relate to the healthcare aspects defined in healthcare program 640. Provider 7 receives the contractual amount for the office visit and the blood test.

Later during Day 1, Patient 660 visits Provider 7. Prior to Day 1, Provider 7 performed a D-dimer concentration blood test on Patient 660, and the blood test returned a positive result. Provider 7 now performs a 64-Row multidetector computed tomography angiography (MDCTA) test for diagnosing whether Patient 660 has a pulmonary embolism. Provider 7 reviews the test results and detects a pulmonary embolism in Patient 660. Provider 7 believes that anticoagulation therapy will resolve the pulmonary embolism, prescribes heparin, and advises Patient 660 to obtain a second opinion. Provider 7 may request referral information for Patient 660 from the provider pool.

Provider 7 submits a payment request to Payer 625 after the visit. Payer 625 processes the payment request through the payment system 630, determines that the office visit and MDCTA test should be paid, then passes all, or alternately, a portion of, the payment request to the member management system 635. The member management system 635 verifies that Provider 7 participates in healthcare program 640 and healthcare program 645, then checks the payment request against the qualifications for healthcare program 640 and healthcare program 645. The MDCTA qualifies for both healthcare program 640 and healthcare program 645. Healthcare program 640 provides the greater reward so the member management system 635 continues processing for healthcare program 640, but not for healthcare program 645 so Provider 7 is not double rewarded for the same action. Alternatively, the lesser reward may be processed, or both rewards may be processed.

The member management system 635 makes Provider 7 part of the unbounded virtual team of providers who render services for Patient 660, for example, through database records. Virtual teams are preferably related to a particular healthcare aspect, therefore, at this point, the healthcare program 640 virtual team for Patient 660 includes Provider 7. Alternately, Provider 7 may be added to a healthcare program 645 unbounded virtual team for Patient 660 even if Provider 7 did not qualify for and/or did not obtain a reward through healthcare program 645. Adding Provider 7 to a healthcare program 645 team may occur if the healthcare aspects in healthcare program 640 and healthcare program 645 are related to one another.

The member management system 635 may determine the number of patients for whom Provider 7 renders services within the scope of healthcare program 640. For example, such a determination may be made by a database query to retrieve the teams of which Provider 7 is a member and by identifying the patient associated with each team. Alternately, the member management system 635 may construct virtual teams of which Provider 7 is a member using database records related to services rendered for patients by Provider 7, may identify patients associated with Provider 7 in one or more databases, or by other suitable manner. For the hypothetical, healthcare program 640 only requires a provider to render services for one or more patients so the member management system 635 next determines whether the patient goals have been achieved for Patient 660. Alternately, a program may require a provider to render services for more or fewer patients.

For the hypothetical, the patient goals are provider specific, in other words, the patient goals related to a provider role need to be achieved to qualify for a reward, but the patient goals related to other provider roles may not need to be achieved for a provider to qualify for a reward. The hypothetical patient goals related to Provider 7's services are that a diagnosis is made and supported by appropriate tests, that invasive tests are not used unless indicated, and that a course of treatment is started. Because the MDCTA is a non-invasive test and heparin was prescribed for an anticoagulation therapy, the member management system 635 determines that the patient goals related to Provider 7's services have been achieved for Patient 660. A patient goal achievement indicator indicating that the patient goal for Patient 660 has been achieved may be generated based on the services rendered by Provider 7. In other words, the patient goal achievement indicator preferably relates to a healthcare aspect, such as medications taken, tests performed, physical conditions identified by tests, or other suitable aspects, exhibited by Patient 660. Alternately, a patient achievement indicator may be determined based on services rendered by other providers, and/or may not be based on the services rendered by Provider 7.

The member management system 635 then determines whether Provider 7 has achieved the provider goals related to Provider 7's services. For the hypothetical, the provider goal for healthcare program 640 is defined to be 60% or more of the patients within the scope of healthcare program 640 treated by the provider achieving the patient goals. Alternatively, other suitable provider goals may be used. The member management system 635 may determine a provider goal achievement indicator based on the patient achievement indicators for the patients treated by Provider 7. The provider goal achievement indicator preferably indicates whether Provider 7 is eligible for a reward after treating Patient 660. If the provider goal achievement indicator indicates a reward, the member management system 635 may increase the payment amount determined by the payment system 630 by a bonus payment, where the bonus payment may be based on an incentive formula that uses the role value assigned to Provider 7. Provider 7 is then paid the payment amount, which includes the bonus. Alternatively, the payment amount and the bonus, or other suitable reward, may be remitted to the provider separately. A reward may be a monetary payment, public recognition, or other suitable incentive.

Later on Day 1, Patient 660, who has been diagnosed with a pulmonary embolism, visits Provider 9 to discuss surgical options. For example, Provider 7 may have accessed the provider pool, reviewed information related to Provider 9, and referred Patient 660 to Provider 9 for a second opinion. Provider 9 and Patient 660 determine that surgery is not warranted for Patient 660's condition. Provider 9 accesses the member management system 635 and views information related to Provider 7 and Provider 8. Provider 9 determines that Provider 8 could help Patient 660 maintain an effective anticoagulation therapy regimen. Provider 9 submits a payment request and a referral request to Payer 625. Payer 625 processes the payment request and the referral through the payment system 630, which determines that the payment request should be paid and the referral should be accepted. The payment system 630 then passes the payment request and the referral to the member management system 635. The member management system 635 makes Provider 9 part of a healthcare program 645 virtual team of providers who render services for patient 5; for example, through database records. At this point, the healthcare program 645 virtual team for Patient 660 includes only Provider 9, and the healthcare program 640 virtual team for Patient 660 includes only Provider 7. Alternately, Provider 7 may be added to the healthcare program 645 virtual team for Patient 660 because of a referral to Provider 9 and/or Provider 9 may be added to the healthcare program 640 virtual team.

The member management system 635 verifies that Provider 9 participates in healthcare program 645, then checks the payment request against the criteria in healthcare program 645. For Patient 660's diagnosed condition, the decision to avoid surgery is within the scope of healthcare program 645 for Provider 9. The member management system 635 then determines the number of patients for whom Provider 9 renders services within the scope of healthcare program 645. Because, within the scope of healthcare program 645, Provider 9 renders services only for Patient 660 and, for the hypothetical, healthcare program 645 requires a provider to render services for 2 or more patients to qualify for a reward, the member management system 635 takes no further action for healthcare program 645.

However, the member management system 635 may also pass the referral request to a referral program 646 that providers are automatically associated with when they register with the member management system 635. Alternatively, the referral program 646 may be like healthcare programs 640 and 645 and may require a provider to intentionally participate. Alternately, referrals may be a criterion within a healthcare program 640, 645. The member management system 635 may make Provider 9 a member of a virtual team of providers who render referral services for Patient 660. The member management system 635 may create a virtual team for Patient 660 by associating Provider 9 with Patient 660 through database records, for example. At this point, the referral program 646 virtual team for Patient 660 includes Provider 9. Alternatively, virtual teams may span across all, or some, of the healthcare programs 640, 645, 646, in which case Patient 660's virtual team may include Provider 7 and Provider 9. Because the payment system 630 determined that the referral should be granted, Provider 9 is rewarded, in this case by a bonus payment for making the referral.

On Day 2, Patient 660 visits Provider 8. Provider 8 accesses the member management system 635 to view Patient 660's electronic health record, which may be updated with information supplied by Provider 7 and/or by Provider 9. Because Provider 8 is not a member of the healthcare program 640 or healthcare program 645 virtual team for Patient 660, Provider 8 may not have access to the full information related to Patient 660's visits to Providers 7 and 9. Alternately, Patient 660 may access the member management system 635 and permit Provider 8 to view information supplied by Providers 7 and 9, or other suitable information. Provider 8 then consults with Patient 660 to establish an anticoagulation therapy regimen that fits Patient 660's lifestyle and diet to supplement the heparin prescribed by Provider 7.

Provider 8 submits a payment request to Payer 625, who processes the payment request through the payment system 630. The payment system 630 determines that Provider 8 should be paid for the office visit and for creating the supplemental anticoagulation therapy regimen. The payment system 630 then passes the payment request to the member management system 635, which verifies that Provider 8 participates in healthcare program 640. The member management system 635 then checks the payment request against the criteria in healthcare program 640 and determines that the office visit and creating the supplemental anticoagulation therapy regimen are within the scope of healthcare program 640.

The member management system 635 makes Provider 8 part of the healthcare program 640 virtual team of providers who render services for Patient 660, for example, through database records. Virtual teams are preferably created or modified at the time the member management system 635 receives a request for payment, and preferably include providers for a set duration, for example, for one year from the last services rendered for a patient. By becoming members of the healthcare program 640 virtual team of providers who render services for Patient 660, Providers 7 and 8 may be able to access clinical or other information pertaining to Patient 660 through the member management system 635. Alternatively, Provider 9 may be included in the healthcare program 640 virtual team for Patient 660 by virtue of the referral to Provider 8 and may be able to access clinical information pertaining to Patient 660.

The member management system 635 then determines how many patients for whom Provider 8 renders services within the scope of healthcare program 640. Because healthcare program 640 only requires a provider to render services for one or more patients, the member management system 635 next determines whether the patient goals related to Provider 8's services have been achieved for Patient 660. The patient goals related to Provider 8's services are that an anticoagulation therapy regimen be created and that the provider follow-up with the patient every three months. Because the anticoagulation therapy regimen was just created, the member management system 635 determines that the patient goals have been achieved for Patient 660.

The member management system 635 then determines whether Provider 8 has achieved the provider goals related to Provider 8's services. Because the provider goal is defined to be 60% or more of the patients within the scope of healthcare program 640 treated by the provider achieving the patient goals, the member management system 635 determines that Provider 8 is eligible for a reward. Note that provider goals may differ within the same program, that is, different types of providers (for example, different taxonomy codes) may have different goals within the same program. Alternately, provider goals may be the same, such as achieving the patient goals.a In either event, the member management system 635 may increase the payment amount determined by the payment system 630 by a bonus payment, where the bonus payment may be based on an incentive formula that uses the role value assigned to Provider 8.

On Day 3, Patient 650 visits Provider 7 again. The blood test performed on day 1 returned a positive result. Provider 7 now performs a 64-Row MDCTA test for diagnosing whether Patient 650 has a pulmonary embolism. Provider 7 reviews the test results and detects a pulmonary embolism in Patient 650. However, the pulmonary embolism is small and Patient 650 refuses to entertain any ideas of treatment.

Provider 7 submits a payment request to Payer 625 after the visit. Payer 625 processes the payment request through the payment system 630, determines that the office visit and MDCTA test should be paid, then passes the payment request to the member management system 635. The member management system 635 verifies that Provider 7 participates in healthcare program 640 and healthcare program 645, then checks the payment request against the criteria in healthcare program 640 and healthcare program 645. The MDCTA is part of the criteria for both healthcare program 640 and healthcare program 645, but healthcare program 640 provides the greater reward so the member management system 635 continues processing for healthcare program 640, but not for healthcare program 645 so Provider 7 is not double rewarded for the same action. The member management system 635 makes Provider 7 part of the healthcare program 640 virtual team of providers who render services for Patient 650, for example, through database records. At this point, the healthcare program 640 virtual team for Patient 650 includes only Provider 7.

The member management system 635 then determines how many patients for whom Provider 7 renders services within the scope of healthcare program 640. Because healthcare program 640 only requires a provider to render services for one or more patients, and Provider 7 renders services for two patients, the member management system 635 next determines whether the patient goals related to Provider 7's services have been achieved for Patient 660 and for Patient 650. The patient goals related to Provider 7's services are that a diagnosis is made and supported by appropriate tests, that invasive tests are not used unless indicated, and that a course of treatment is started. Because the MDCTA is a non-invasive test and heparin was prescribed for an anticoagulation therapy, the member management system 635 determines that the patient goals related to Provider 7's services have been achieved for Patient 660, and a patient goal achievement indicator indicating that the patient goals have been achieved for Patient 660 may be generated. In contrast, although the MDCTA is a non-invasive test, provider 7 did not start treatment for Patient 650's pulmonary embolism. Therefore, the member management system 635 determines that the patient goals related to Provider 7's services have not been achieved for Patient 650, and a patient goal achievement indicator indicating that the patient goals for Patient 650 have not been achieved may be generated.

The member management system 635 then determines whether Provider 7 has achieved the provider goals related to Provider 7's services. Because the provider goal is defined to be 60% or more of the patients within the scope of healthcare program 640 treated by the provider achieving the patient goals, and, based on the generated patient goal achievement indicators, only 50% of Provider 7's patients within the scope of healthcare program 640 achieved the patient goals, the member management system 635 determines a provider goal achievement indicator that indicates Provider 7 is not eligible for a reward.

The member management system 635 may then pass all, or a portion of, the payment request to healthcare program 645 because Provider 7 was not eligible for a reward under healthcare program 640. The member management system 635 may make Provider 7 part of the healthcare program 645 virtual team of providers who render services for Patient 650, for example, through database records. At this point, the healthcare program 645 virtual team for Patient 650 includes only Provider 7. The member management system 635 then determines how many patients Provider 7 renders services for within the scope of healthcare program 645. Because healthcare program 645 requires a provider to render services for two or more patients, and Provider 7 renders services for only one patient in healthcare program 645, the member management system 635 again determines that Provider 7 is not eligible for a reward. Alternately, even if the provider goal achievement indicators indicates that Provider 7 is eligible for a reward under healthcare program 640, Provider 7 may be added to the healthcare program 645 virtual team for Patient 650.

At this point in time, even though Providers 8 and 9 may access the member management system 635, Providers 8 and 9 may not be able to access clinical or other information pertaining to Patient 650 because they are not part of either virtual team for Patient 650. Suitable levels of access to patient information may be permitted in alternate embodiments.

After Patient 650's visit, Patient 655 also visits Provider 7 on Day 3. Patient 655 is experiencing shortness of breath, rapid breathing, and is coughing up blood. Provider 7 performs a 64-Row MDCTA test for diagnosing whether Patient 655 has a pulmonary embolism. Provider 7 reviews the test results and detects a pulmonary embolism in Patient 655. Provider 7 believes that surgery is needed to resolve the pulmonary embolism, and refers Patient 655 to Provider 9 after accessing the member management system 635 and viewing information relating to Provider 9 and/or the services rendered by Provider 9 and/or the results obtained by Provider 9 for Provider 9's patients.

Provider 7 submits a payment request to Payer 625 after the visit. Payer 625 processes the payment request through the payment system 630, determines that the office visit and MDCTA test should be paid, then passes the payment request to the member management system 635. The member management system 635 verifies that Provider 7 participates in healthcare program 640 and healthcare program 645, then checks the payment request against the criteria in healthcare program 640 and healthcare program 645. The MDCTA is part of the criteria for both healthcare program 640 and healthcare program 645, but healthcare program 640 provides the greater reward so the member management system 635 continues processing for healthcare program 640, but not for healthcare program 645 so Provider 7 is not double rewarded for the same action.

The member management system 635 makes Provider 7 part of a virtual referral team for Patient 655 and/or a part of a healthcare program 640 virtual team for Patient 655 as described above. The member management system 635 then determines how many patients for whom Provider 7 renders services within the scope of healthcare program 640. Because healthcare program 640 only requires a provider to render services for one or more patients, the member management system 635 next determines whether the patient goals related to Provider 7's services have been achieved for Patients 650, 655, and 660. The patient goals related to Provider 7's services are that a diagnosis is made and supported by appropriate tests, that invasive tests are not used unless indicated, and that a course of treatment is started. Because the MDCTA is a non-invasive test and heparin was prescribed for an anticoagulation therapy, the member management system 635 determines that the patient goals related to Provider 7's services have been achieved for Patient 660. In contrast, although the MDCTA is a non-invasive test, Provider 7 did not start treatment for Patient 650's pulmonary embolism. Therefore, the member management system 635 determines that the patient goals related to Provider 7's services have not been achieved for Patient 650. Because the MDCTA is a non-invasive test and surgery was recommended, the member management system 635 determines that the patient goals related to Provider 7's services have been achieved for Patient 655. Patient goal achievement indicators may be generated for each Patient 650, 655, and 660.

Alternately, had Patient 650 recanted and went back to Provider 7 (or another provider in the provider pool) to start treatment, the member management system 635 may have determined that the patient goals for Patient 650 were achieved when Provider 7 submitted the provider payment request for services rendered for Patient 655. Thus, it may be possible for unsuccessful virtual teams to become successful and vice versa as treatment for a patient progresses. Therefore, whether a provider is eligible for a reward may be dynamic and may change over time as the provider renders services for more patients, or the same patients.

Incentives may stem from information access which may permit providers to recommend or refer other high performing providers. In other words, knowing which providers consistently deliver high quality, effective healthcare services (for example, by viewing providers' provider goal achievements or other suitable data) may incentivize a provider to send a patient to a high quality, effective healthcare provider for treatment results, treatment efficiency, treatment costs, achieving provider goals, or other suitable reasons.

Virtual teams are preferably not bound by pre-existing arrangements between providers, and providers are free to select high performing teammates based on performance indicators such as the number of or percentage of successful virtual teams a provider is a member of, for example. Even when providers are bound by pre-existing arrangements, providers may be free to select high performing teammates based on performance indicators such as the number of or percentage of successful virtual teams a provider is a member of without accounting for the pre-existing arrangements. Virtual teams are also preferably not bound by a pre-determined number of providers and may grow and shrink as various providers either provide services for a patient or stop providing services for a patient.

The member management system 635 then determines whether Provider 7 has achieved the provider goals related to Provider 7's services. For the hypothetical, the provider goal is defined to be 60% or more of the patients within the scope of healthcare program 640 treated by the provider achieving the patient goals. Here, over 66% of Provider 7's patients within the scope of healthcare program 640 achieved the patient goals, and the member management system 635 determines that Provider 7 is eligible for a reward. The member management system 635 may increase the payment amount determined by the payment system 630 by a bonus payment, where the bonus may be based on an incentive formula that uses the role value assigned to Provider 7.

Before Patient 655 sees Provider 9 for surgery, Provider 9 accesses the member management system 635 and elects to be removed from healthcare program 645. The member management system 635 may retain a database record for Provider 9, which may make it easy for Provider 9 to participate in healthcare programs again, or the member management system 635 may remove information related to Provider 9 from the databases, except for clinical information pertaining to patients for whom Provider 9 rendered services.

Patient 655 sees Provider 9 who immediately schedules a pulmonary thromboendarterectomy. After the surgery, Provider 9 submits a payment request to Payer 625. Payer 625 processes the payment request through the payment system 630, which determines that the surgery should be paid for. The payment system 630 then passes all, or a portion of, the payment request to the member management system 635. The member management system 635 verifies that Provider 9 is not participating in the healthcare program 640 or the healthcare program 645. The member management system 635 stops processing and instructs the payment system 630 to pay Provider 9 without a bonus, even though Provider 9 would have been eligible for a bonus if Provider 9 still participated in the healthcare program 645. Provider 9 is not made part of the healthcare program 640 or healthcare program 645 virtual team for Patient 655. Alternately, Provider 9 may be added to the healthcare program 645 virtual team for Patient 655 based on the rendered services qualifying for healthcare program 645, even if Provider 9 is not participating in healthcare program 645. Thus, virtual teams may have full access to a patient's clinical and/or other data, even if all of the providers who render healthcare services for the patient are not participating in a healthcare program.

The preceding hypothetical situations illustrate the versatility incentive system embodiments may provide. For example, virtual team members for a patient may have access to information relevant to the patient's care as defined by a healthcare program. As another example, payers and/or providers may determine what to reward and how. The incentive system may have low overhead for providers and be easy to use because it builds on existing payer systems. The preceding hypothetical situations described rewards where providers were rewarded based solely on each provider's actions, however, reward criteria could be defined to include actions from other providers and/or patients. Additionally, a provider's services may qualify for an incentive or reward, but may not directly address a patient goal.

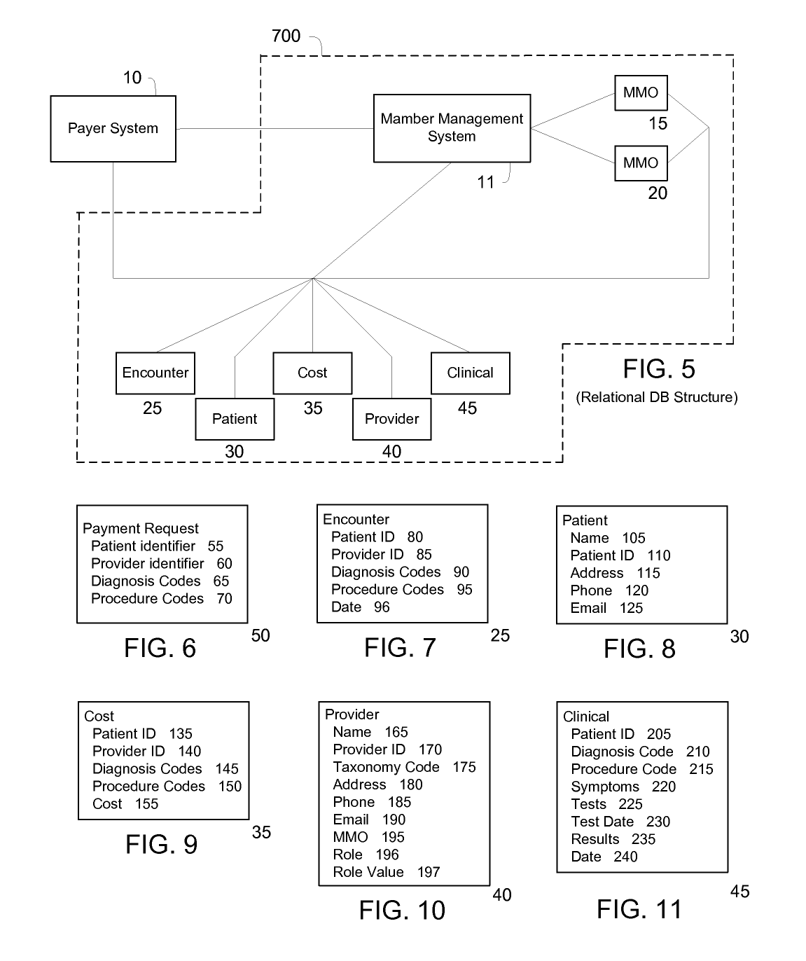

Referring to FIGS. 5-13, processing for a preferred embodiment of an incentive system is schematically illustrated. An incentive system 700 may operate with an existing payer payment system 10. The payment system 10 receives a payment request 50 from a provider, for example, as an electronic request sent from the provider's computer to the payment system 10. The provider payment request 50 may include a service identifier such as medical codes, for example, a patient identifier 55, and a provider identifier 60. Medical codes may be, but are not limited to, diagnosis codes 65 and procedure codes 70. Medical codes may be based on the International Statistical Classification of Diseases and Related Health Problems (“ICD9”), Current Procedural Terminology, 4^{th} Edition (“CPT4”), National Drug Code (“NDC”), Healthcare Common Procedure Coding System (“HCPCS,”) Hospital Revenue Codes (“RV,”) Diagnosis-Related Group (“DRG”), Logical Observation Identifiers, Names and Codes (“LOINC”), or other suitable codes and/or systems. Alternatively, other information such as current clinical data (for example, information related to a patient's most recent visit to a provider) may be included in the payment request 50. Other information may be included in the payment request, and not all of the information illustrated in FIG. 2 may be required. The payment system 10 determines whether the payment request 50 should be paid. If the payment request 50 should be paid, the payment system 10 determines a payment amount.

In a preferred incentive system 1, additional software 11, referred to as a member management system 11, communicates with the existing payer payment system 10. The member management system 11 receives all, or a portion of, the payment request 50 after the payment system 10 determines that the payment request 50 should be paid. If the payment system 10 determines that the payment request 50 should not be paid, the incentive system 700 may not receive the payment request 50. Alternately, the member management system 11 may receive the payment request 50 to add a provider to a virtual team for a patient, even if the payment request should not be paid.

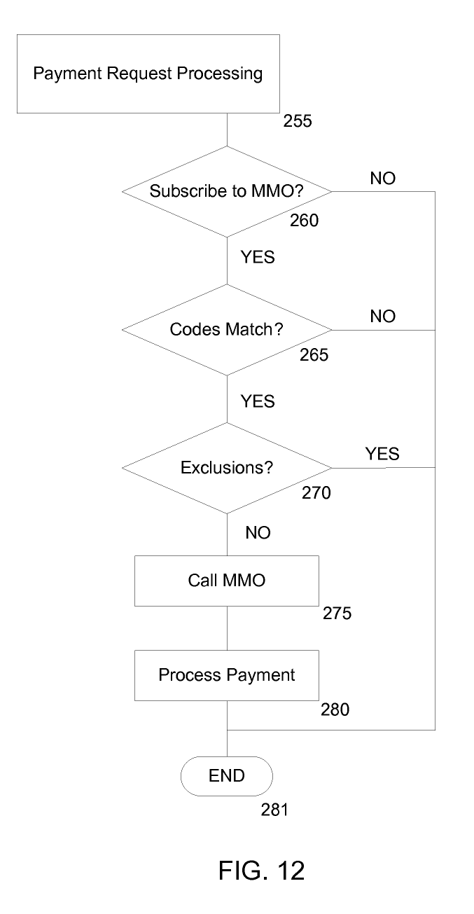

When the member management system 11 receives the payment request 50, the member management system may run a payment request processing routine 255 (FIG. 12) to determine whether the payment request 50 meets pre-qualification criteria for a reward. For example, the payment request routine 255 may run a participation routine 260 to determine whether the provider is included in a pool of providers who participate in a software implementation of a healthcare program such as a member management object 15, 20. For example, the subscription routine 260 may pass the provider identifier 60 from the payment request 50 to a provider database 40 with a database request to return member management object identifiers 195 associated with a provider identifier 170 that matches the provider identifier 60.

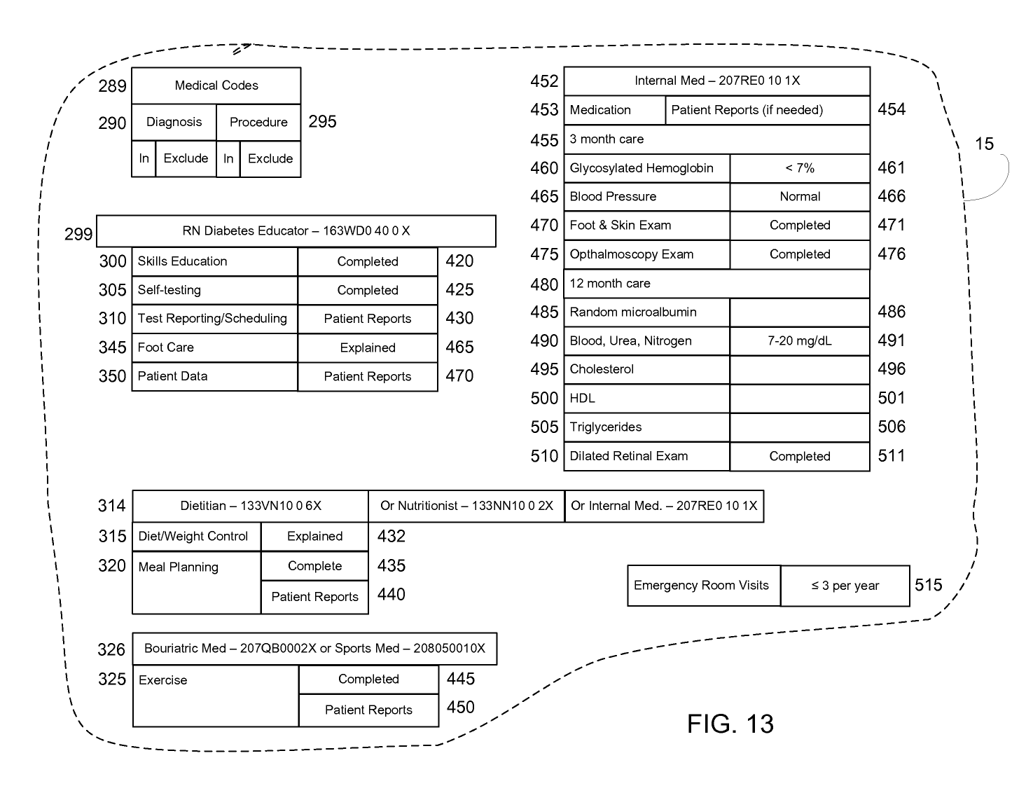

The payment request routine 255 may determine whether the patient identified in the provider payment request is included in a pool of patients. A patient pool preferably includes patients who contract with the payer and who meet qualifying criteria for the incentive program. One manner for determining whether a patient qualifies for the incentive program is for the payment request routine 255 to run a verification sub-routine 265 to determine whether the medical codes 65, 70 from the payment request 50 match medical codes 290, 295 (FIG. 13) in a member management object 15, 20. The verification sub-routine may query the member management objects 15, 20 for their medical codes 290, 295 and compare the results against the medical codes 65, 70 from the payment request. The payment request routine 255 may also run an exclusions sub-routine 270 to determine whether the patient is excluded from either member management object 15, 20. For example, the exclusions sub-routine 270 may compare the medical codes 65, 70 from the payment request against the medical codes 290, 295 in the member management objects 15, 20 to determine whether any medical codes 65, 70 are found in an exclusion list in the member management objects 15, 20.

If the member management system 11 identifies a provider from the provider pool, a patient from the patient pool, and/or that the payment request 50 pre-qualifies for a reward, the member management system 11 may call a member management object 15 or 20 and may pass the payment request 50, or a portion of the payment request 50, to the member management object 15 or 20. For example, if the medical codes 65, 70 in the payment request 50 relate to diabetes type I, the member management object 15 relates to diabetes type I, and the member management object 20 relates to hypertension, the member management system 11 will call the member management object 15, but not the member management object 20 (for example, because the medical codes 65, 70 do not match the medical codes 290, 295 in the member management object 20).

The hypothetical member management object 15 described below relates to diabetes type I. However, a member management object may relate to any medical condition, including diseases, cost containment, or other suitable healthcare aspect.

Member management objects may be created by a payer, by providers, or by a payer and providers working in conjunction with one another. A purpose for a member management object may be to provide a set of criteria or guidelines, such as, but not limited to, medical codes, costs, procedures performed, procedures not performed, patient goals, and/or provider goals, that are used to define whether providers qualify for a reward and/or whether patients qualify for rewards. By defining what the criteria are, a payer and/or providers may design member management objects to improve healthcare by creating incentives for healthcare providers and/or patients to perform certain tasks, or to refrain from performing certain tasks. Member management objects preferably contain information defining desired actions, activities, or results for patients with healthcare aspects that are within the scope of the member management object. Member management objects also preferably define a pool of healthcare providers who may render services within the scope of the member management object and a pool of patients with conditions that are eligible for the member management object. In some embodiments, a member management object may be a specialized medical registry.

For purposes of the following discussion, the patient previously visited an internal medicine doctor who diagnosed the patient with diabetes type I, but did not perform the 3 month continuing care procedures 455. The patient also previously visited a registered nurse practitioner who taught diabetes management skills 300 to the patient, taught the patient to self-test blood sugar levels 305, how to schedule and report blood sugar level tests 310, and taught the patient how to properly care for the patient's feet 345. The doctor and the nurse both participate in the member management object 15. They are both members of a member management 15 unbounded virtual team for the patient as a result of submitting payment requests for the rendered services.

The current payment request 50 is from a registered dietitian and the medical codes 65, 70 relate to diet and weight control education 315 and to meal planning 320.

When the member management object 15 receives the payment request 50, the member management object 15 may run a subroutine using the medical codes 65, 70 from the payment request 50 to verify that the services qualify for an incentive program. For example, the medical codes from the payment request 50 may include a diagnosis code 65 for diabetes type I and procedure codes 70 for weight control information and meal planning. The member management object 15 may compare the medical codes 65, 70 from the payment request 50 against the medical codes 290, 295 contained in the member management object 15 and associated with diet and weight control 315 and with meal planning 320.

If the medical codes 65, 70 from the payment request 50 do not match any medical codes in the incentive program, the member management object 15 may stop processing the payment request 50 without altering the payment amount determined by the payer system 10. The member management object 15 may then instruct the payer system 10 to pay the provider. Alternately, the member management object 15 may add the provider to the unbounded virtual team for the patient.

If the medical codes 65, 70 from the payment request match medical codes in the incentive program, the member management system 15 may update the encounter database 25 with information related to the patient's visit to the registered dietitian. For example, the member management object 15 may query the encounter database 25 for the record containing a patient identifier 80 that matches the patient identifier 55 from the payment request 50. The member management object 15 may then write information, such as the medical codes 65, 70 and the provider identifier 60 to the encounter database 25 in matching fields such as the medical code fields 90, 95 and the provider identifier field 85. Because the patient previously visited an internal medicine doctor and a registered nurse practitioner and the member management object 15 previously processed payment requests from the internal medicine doctor and the registered nurse practitioner, the patient may be associated with the doctor and the nurse. For example, the fields in the encounter database 25 may contain data linking the patient with the internal medicine doctor and the registered nurse practitioner as well as the medical codes for the services rendered by the internal medicine doctor and the registered nurse practitioner.

The member management object 15 may thus build an unbounded virtual team of providers, each rendering services for a particular patient, by updating the encounter database 25. For example, by querying the encounter database 25 with a patient identifier, the member management object 15 may determine all of the providers who render services for the patient associated with the patient identifier. Because the providers become members of a patient's team simply by subscribing to a member management object and subsequently submitting payment requests, it is not necessary for there to be a professional, physical, or other pre-existing arrangement between providers as a condition to becoming an unbounded virtual team member for a patient.

Alternatively, other embodiments may build a patient's team of providers by creating a link or pointer between a patient's record in the patient database 30 and a provider's record in the provider database 40. Other databases and/or programming techniques may be used to create and track virtual teams for patients. Preferably, virtual teams for a patient are confined to a particular program; that is, providers are preferably linked to a patient's virtual team by the healthcare aspect for which services are rendered.

After adding the registered dietitian to the patient's virtual team of providers for the member management object 15, the member management object 15 may determine the percentage of successful teams of which the registered dietitian is a member. First, the member management object may query the encounter database 25 with the registered dietitian's provider identifier to obtain a list of all the patient identifiers the registered dietitian is associated with. The member management object 15 may then use each patient identifier to query the encounter database 25, the clinical database 45, or both, to retrieve medical codes and/or other clinical data associated with each patient identifier. Clinical data may be provided to an incentive system, for example, by requiring each provider to submit clinical data with a payment request 50 by entering data in an electronically generated form or other suitable manner. Alternatively, clinical data may be accessible through an Electronic Health Record, a Community Health Information Exchange, or other suitable resource. The clinical data may include the medical codes 65, 70 as well as data relating to a patient's symptoms; tests performed; test, clinical, or other results; the date; and/or the date tests were performed; or other suitable information.

Clinical data and/or encounter data may be used by the member management object 15 to determine whether patient goals are achieved for each patient identifier at the time the provider submits the payment request 50. For example, patient goals may be defined to include goals associated with procedures for treating a patient's medical condition, or may be associated with other healthcare aspects. The goals may be defined in the member management object 15, and, for the hypothetic example, may include performing the 3 month check 455 every 3 months, performing the 12 month check 480 once a year, that the patient received skills education 300, received self testing education 305, learned how to schedule, test, record, and report blood sugar levels 310, learned proper foot care 345, reports blood sugar test results at predetermined intervals 430 (every month, for example), received weight control education 432, received a meal plan 435, and the patient reports 440 compliance with the meal plan (at two month intervals, for example) after the meal plan is completed. Patient goals may be fewer or greater in number, and may be achieved by visiting a single provider, or by visiting multiple providers. The member management object 15 may account for patient goals associated with some of the taxonomy codes, with all of the taxonomy codes, or patient goals may not be associated with any taxonomy codes, or other suitable provider role indicator. Defining the patient goals, and defining how the patient goals are achieved are preferably flexible and may be defined or changed in a suitable manner by payers, providers, or both, and may encourage team participation.

For the present hypothetic example, when the provider submits the payment request 50, the member management object 15 may run a subroutine that retrieves all of the patient identifiers associated with patients the provider rendered services for (including the patient identifier in the payment request 50) and determines whether the patient goals are achieved for each patient identifier. Determining whether patient goals are achieved is preferably performed in real time to capture changes that occur as treatments progress. Thus, whether a particular virtual team was successful or not successful at achieving predefined patient goals is not static, but may change each time a provider on a virtual team submits a provider payment request, may change due to the passage of time, or for other suitable reasons. For example, if the provider has rendered services, and requested payment, for 10 patients where the patients and services are within the scope of the member management object 15, the member management object 15 may determine that for six of the patient identifiers patient goals are achieved at the time the payment request 50 is submitted to the member management system 15. For example, for these six patient identifiers, the member management object 15 may determine that the patient goals have been achieved because of various services rendered for the patient by various providers at various times.

The member management object 15 may also determine that for three of the patient identifiers the patient goals are not achieved. For example, one patient may have missed a 3 month check 455, one patient may have missed a 12 month check 480, and one patient may have stopped reporting blood sugar levels 430. For the current patient in the hypothetical, because the patient meal compliance reporting goal 440 is defined to be at two month intervals after the meal plan is completed, and the meal plan was completed for the patient identifier 55 in the request for payment 50 within two months, the member management object 15 may determine that the patient goals are achieved for the patient identifier 55 in the request for payment 50. Thus, the member management object 15 may determine that the patient goals were achieved for 7 of the 10 patients the registered dietitian provided services for at the time the provider payment request 50 was received.

The member management object 15 may define a provider's goal to be having at least 60% of the patients the provider renders services for meet the patient goals. For the hypothetic example, the registered dietitian would achieve the provider goal and be eligible for a reward, such as a bonus payment. Note that whether patient goals are achieved is preferably determined in real time at the time a request for payment is submitted. Therefore, providers may be rewarded, or not, based on the current healthcare situation for the patients a provider renders services for.

The patient goals may be achieved by visiting one provider, for example, when there are relatively few patient goals or the patient goals all relate to services rendered by a provider acting in one provider role. With respect to the present hypothetical, an internal medicine doctor may undertake the necessary procedures and/or tests to achieve the patient goals discussed above. Other providers rendering services for the patient may then be eligible for a reward. For example, a sports medicine doctor may see a patient and establish an exercise regimen 325. Even though the exercise regimen 325 is not a specific patient goal in the hypothetical example (as discussed above), the sports medicine doctor may be made part of the patient's virtual team and may earn a reward for the exercise regimen 325 if the sports medicine doctor meets the provider goals, for example, being on a predetermined percentage of successful teams.

One reason for making the provider goal less than achieving 100% of the patient goals may be to encourage providers to take difficult cases without fear of losing eligibility for rewards. Another possible reason for making the provider goal less than achieving 100% of the patient goals may be to prevent providers from dropping patients who are not achieving the patient goals.

After determining that the registered dietitian is eligible for a reward, the member management object 15 may query the provider database 40 for the registered dietitian's role value 197. A role value may be a number used as a multiplier to determine a bonus amount. For example, referring to FIG. 13 weight control education 315 and meal planning 320 may be provided by a registered dietitian (133VN1006X), a nutritionist (133NN1002X), or an internal medicine physician concentrating on endocrinology, diabetes, and metabolism (207RE0101X). A payer may allocate a first bonus amount for weight control education 315 and a second bonus amount for meal planning 320. However, because of differing education levels, income expectations, or other factors, the payer may apply an incentive formula to the bonus payment to adjust the bonus payment according to who rendered the services. For example, each taxonomy code 314 (133VN1006X, 133NN1002X, and 207RE0101X) may be assigned a different role value 197 in the provider database 40. The 133NN1002X (nutritionist) taxonomy code may be assigned a role value of 0.8, the 133VN1006X (registered dietitian) taxonomy code may be assigned a role value of 1.0, and the 207RE0101X (internal medicine physician) taxonomy code may be assigned a role value of 1.2. An exemplary incentive formula may be to multiply the bonus payment by the role value, thus resulting in different bonus payments depending on who rendered the services.

Once the member management service 15 determines a reward, such as a bonus payment, the member management service 15 may provide instructions to the payer system 10 to increase the payment amount by the bonus amount and to pay the provider. Alternatively, the member management object 15 may provide instructions to the member management system 11 to increase the payment amount and to pay the provider, or to instruct the payer system 10 to pay the provider the increased payment amount.

Using incentive system embodiments may encourage providers and/or patients to engage in activities that may make healthcare treatment more effective, efficient, and at reduced costs. For example, by making the doctor, the nurse, and the registered dietician part of a virtual team for a patient with diabetes type 1, each provider may have access to information regarding the patient's treatment. Such access may allow providers to tailor their treatment to work with the treatments of the other providers, and may allow providers to identify where additional or different treatments may be needed. Transparent information, including, but not limited to, which providers are on a relatively high number or percentage of successful virtual teams, i.e., where the patient goals are achieved or other suitable metric, and what types of providers or provider roles are present on a relatively high number or percentage of successful virtual teams provide information to providers to assist them make healthcare choices, such as what treatments to undertake, or which providers, or what type of providers, to refer patients to, to best care for a particular patient or a group of patients. The patient may also have access to the treatment information, and may be encouraged to fully participate and engage the providers. Rewards may be tailored to encourage actions that improve the patient's health and/or reduce costs. Often, the two may go hand in hand.

In a preferred embodiment, a payer may operate 2 member management objects for the same disease, medical condition, or other suitable healthcare aspect. For example, a payer may operate a member management object for type I diabetes that applies to healthcare providers in the Pacific Northwest. A similar member management object for type I diabetes may apply to healthcare providers in New England.

The two member management objects may have common criteria as well as differing criteria. By statistically analyzing and/or sampling the patients and clinical results in each member management object, the payer may be able to isolate or identify criteria that have a positive impact on patient health, program costs, or other factors. The isolated or identified criteria may be used to improve the two member management objects, and/or other member management objects.

For a hypothetical example, consider two programs that are operating for a common condition such as Type II Diabetes Mellitus. Assume that both programs have identical member goals such as an HBA1c laboratory value measured quarterly with a result that is less than 7.0%. The incentive payment values are the same and the provider goal is a simple 60% of members achieving the member goal for each program. However, assume that one program operator believes that better results can be achieved by using simple case management phone calls. To that end, the program operator includes extends the provider eligibility definition (for example, taxonomy codes) to include case managers. Assume that this is the only difference between the two programs. Because the programming of the programs is based on objective, definable goals, and because the two programs are similarly defined and measurable, differences in results are directly measurable and attributable to the one difference between the two programs. Observing the different results and correlating the different results to the one difference between the two programs may will lead to improved knowledge and better future decisions. In other words, the positive or negative effect of including case manages in the one program may be determined, and the less effective program may be modified to mimic the more effective program. Comparing similar, but slightly different programs, may be used to discover and implement new knowledge, measure results, and iterate and refine knowledge and new discoveries though the same process.

Many alternate arrangements for incentive programs are possible. For example, a single incentive program may be administered by more than one health plan or government payer. In such an embodiment, a patient may need to be an enrollee in each payer's plan, or the payers may need to agree to share patient information in a manner that is compliant with sharing patient data, such as with the Health Insurance Portability and Accountability Act (“HIPAA”), for example. However, individual providers would preferably only need to register with one payer. Incentive programs with a broad geographic reach, for example, could be implemented where application of an incentive to a particular provider would be calculated according to the specific details of the health plan with which the provider registered. For example, although the patient and provider goals are preferably the same for each patient and for each provider, the actual incentive itself, such as a bonus payment, public recognition, or other suitable incentive, could differ from payer to payer. Consider the following hypothetical example. A quality improvement program may be created to improve the care for patients who are immediately post-myocaridal infarction (heart attack). Based on current evidence suggesting that mental health problems, specifically depression, may have a negative effect on recovery in the first year, a program may be designed for such patients to reduce recurrence or improve subsequent functional status by addressing mental health issues. Providers registered with separate health plans are able to join the program and receive incentive benefits while a relatively large patient population may receive improved health care.

Another alternative incentive program may assist with estimating the additional payer obligation associated with offering the incentive program. Many incentive programs define the scope of the planned intervention in purely clinical terms such as the patient's condition. An incentive program designed to estimate the costs of the incentive program may define intervention in clinical terms, and may also constrain the claims or encounters that qualify for the incentive. Constraining the claims or encounters that qualify for the incentive may allow the payer to examine related historical claims to estimate a potential maximum financial exposure resulting from implementing the incentive plan. As a result of having an estimated cost and knowing where the cost stems from, the cost of the incentive plan can preferably be “carved out” of existing budgets. Such an incentive plan may create additional planning safety which may allow for a larger incentive. Thus, providers may be motivated to deliver better health care services while a payer maintains budget neutrality.

Another alternative arrangement may be to use paired and/or overlapping incentive programs to promote innovation toward achieving what may initially seem like oppositional goals. For example, the tension between cost and quality may be addressed through paired and/or overlapping incentive programs. Consider a hypothetical related to Type II Diabetes Mellitus. Type II Diabetes Mellitus may best be treated in a multidisciplinary fashion. Type II Diabetes Mellitus has clear indicators for good care, which makes it a likely candidate for an incentive program related to improving patient health, and at the same time addressing the clear indicators for Type II Diabetes Mellitus can be enormously expensive, especially when considering the secondary conditions and complications that may arise. A paired and/or overlapping incentive program arrangement may thus be created to create an incentive system that rewards achievement of clinical goals known to be associated with high quality health care, and at the same time create a second incentive program designed to reward lower aggregate costs. The cost containment incentives may come from a different bonus pool than the quality improvement incentives. Because of the nexus of the incentive programs having separate bonus pools, a provider who could achieve both the clinical goals and the cost containment goals would preferably be eligible for both incentives. Of course, separate providers may earn the clinical and cost containment goals.

### Hardware Overview

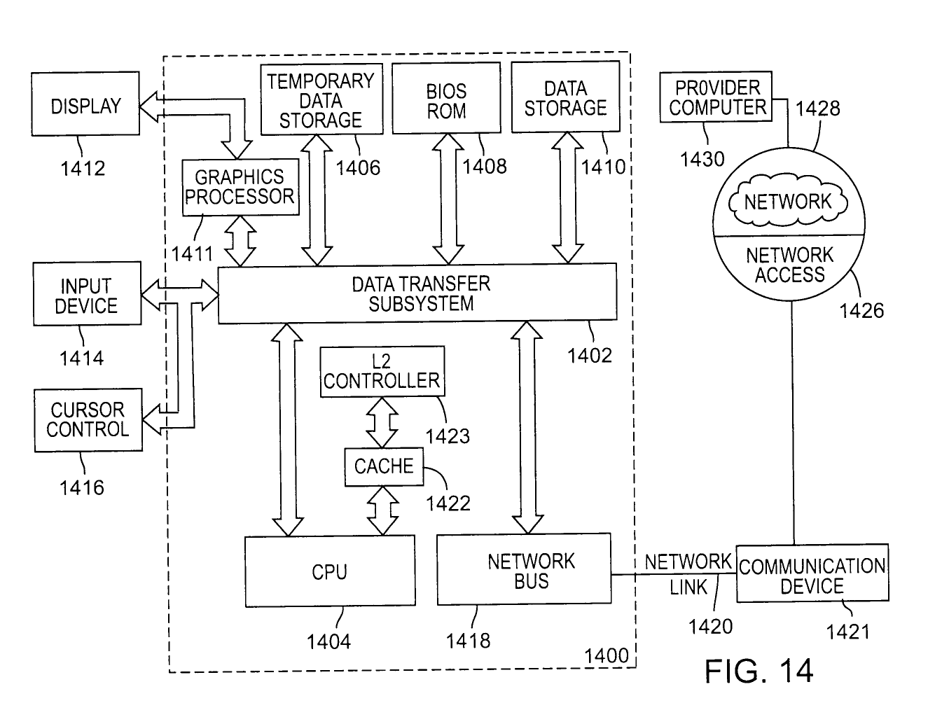

FIG. 14 depicts a computer system 1400 on which embodiments may be implemented, or that may comprise embodiments. Computer system 1400 includes a data transfer subsystem 1402 that transfers data between computer components. The data transfer subsystem 1402 may be a local bus, internal network, or other suitable communication device for transferring information among computer components.

Computer system 1400 may be coupled via the data transfer subsystem 1402 to a graphics processor 1411, which is coupled to a display 1412, such as a liquid crystal display (LCD), for displaying information. An input device 1414, such as a keyboard, and a cursor control device 1416, such as a mouse, or other suitable input devices are coupled to the data transfer subsystem 1402 for transmitting information and commands to a central processing unit (CPU) 1404.

The CPU 1404 is coupled to the data transfer subsystem 1402. The computer system 1400 includes a temporary data storage 1406, such as a random access memory (RAM), virtual memory, or other suitable data storage device, also coupled to the data transfer subsystem 1402 for storing information and instructions to be executed by the CPU 1404. The CPU 1404 is preferably coupled to a cache memory 1422 which is controlled by an L2 controller 1424 for rapidly sending information and instructions to the CPU 1404 in conjunction with information and instructions from the temporary data storage 1406.

The temporary data storage 1406 may also be used to store temporary variables or other information when the CPU 1404 executes instructions. Computer system 1400 further includes a basic input/output system read only memory (BIOS ROM) 1408 or other suitable storage device coupled to the data transfer subsystem 1402 for storing information and instructions telling the computer system 1400 how to operate when the computer system 1400 is initially powered on. A non-volatile data storage device 1410, such as a flash memory, magnetic disk, optical disk, or other suitable device is coupled to the data transfer subsystem 1402 for storing information and instructions when the computer system 1400 is powered off.

Present embodiments relate to using a computer system, such as the computer system 1400, for implementing methods and systems as described above. According to one embodiment, those methods or systems are performed or embodied by computer system 1400 when the CPU 1404 executes instructions carried on a computer-readable medium. “Computer-readable medium” refers to any medium that provides instructions to the CPU 1404, including, but not limited to, non-volatile media, volatile media, and transmission media. Exemplary computer-readable media includes, solid state memory such as flash memory; magnetic memory such as a floppy disk, a hard disk, and magnetic tape; optical memory such as a compact disk; physical memory such as punchcards or tickertape; or other suitable memory such as a RAM, a PROM, an EPROM, a FLASH-EPROM, or any other suitable medium from which a computer can read and/or write instructions.

Such instructions may be read into the temporary data storage 1406, for example, from the data storage 1410. Executing the instructions contained in the temporary data storage 1406 causes the CPU 1404 to perform the process steps described above. In alternative embodiments, hard-wired circuitry may be used in place of or in combination with software instructions. Embodiments are therefore not limited to software, hardware circuitry, or a particular combination of hardware circuitry and software.

Computer readable media may carry instructions to the CPU 1404 for execution singularly or in a variety of combinations. For example, initial instructions may be carried on a remote computer's hard drive. The remote computer can load the instructions into its dynamic memory and send the instructions over a network 1428, such as the Internet, using a communication device such as a modem, wireless transceiver, or other suitable device. A communication device 1421 that is part of the computer system 1400 receives the data from the network 1428 and transfers the data to the data transfer subsystem 1402 using the network bus 1418. The data transfer subsystem 1402 carries the data to the temporary data storage 1406 and/or to the cache 1422, from which the CPU 1404 retrieves and executes the instructions. The received instructions may be stored on the data storage 1410 before or after execution by the CPU 1404.

Network link 1420 may provide a connection to data equipment operated by a network access provider 1426, such as an in-house information technology department, intranet operator, internet service provider, or other suitable network access provider. Network access provider 1426 provides data communication services through a network 1428. A provider's computer 1430 may be connected to the network 1428 and thus communicate data and/or instructions with the computer system 1400.

Computer system 1400 can send and receive data, including program code, through the network 1428, network link 1420, and network bus 1418. For example, a provider using a provider computer 1430 might transmit a payment request through the network 1428, network access provider 1426, and network bus 1418. The received request may be used by the CPU 1404 when it is received, and/or stored in data storage 1410 for later use when executing instructions that cause the computer system 1400 to perform methods such as those described above.

It will be obvious to those having skill in the art that many changes may be made to the details of the above-described embodiments without departing from the underlying principles of the invention.

1. A computer program product, comprising a computer usable medium having a computer readable program code embodied therein, said computer readable program code adapted to be executed to implement a method for facilitating healthcare services, said program code comprising:
computer readable instructions that enable a computer to receive at least a portion of an electronic provider payment request, the portion of the provider payment request including a provider identifier, a patient identifier, and a service identifier representing a current service rendered by the provider, the service identifier related to a medical condition;
computer readable instructions that enable the computer to identify a patient record in a database, the patient record associated with the patient identifier;
computer readable instructions that enable the computer to identify a provider record in a database, the provider record associated with the provider identifier;
computer readable instructions that enable the computer to create a current unbounded virtual team including other providers with unique provider identifiers that are associated with both the patient identifier in a database and with a past service identifier that is related to the medical condition;
computer readable instructions that enable the computer to associate the provider identifier with both the patient identifier and the service identifier in a database to update the current unbounded virtual team associated with the patient identifier by including the provider identifier with the current unbounded virtual team;
computer readable instructions that grant the provider associated with the provider identifier information access to a medical record for the patient, the medical record related to the medical condition and the medical record including clinical data from the other providers who are members of the current unbounded virtual team; and
computer readable instructions that permit the provider to access the medical record for the patient and base further treatment for the medical condition at least in part on the medical record.

2. A computer program product according to claim 1, said program code further comprising:
computer readable instructions that enable the computer to determine whether the provider associated with the provider identifier qualifies for a reward using the service identifier, the provider identifier, and the patient identifier;
computer readable instructions that enable the computer to retrieve at least one unbounded virtual team of which the provider is a member, including the current unbounded virtual team, where the provider identifier is associated with a past service identifier related to the medical condition;
computer readable instructions that enable the computer to determine a patient goal achievement indicator for each retrieved unbounded virtual team, where the patient goal achievement indicator relates to an aspect of the medical condition exhibited by a patient associated with the patient identifier;
computer readable instructions that enable the computer to determine a provider goal achievement indicator using the patient goal achievement indicator for each retrieved unbounded virtual team and the determination of whether the provider associated with the provider identifier qualifies for a reward; and
computer readable instructions that enable the computer to create a reward for the provider associated with the provider identifier based on the provider goal achievement indicator.

3. A computer program product according to claim 2, wherein retrieving at least one unbounded virtual team is further based on the provider identifier being associated with a past service identifier related to the medical condition within a predetermined time.

4. A computer program product according to claim 2, wherein the reward includes a bonus payment.

5. A computer program product according to claim 1, said program code further comprising computer readable instructions that enable the computer to write the provider goal achievement indicator to a database.

6. A computer program product according to claim 1, said program code further comprising:
computer readable instructions that enable the computer to receive an information request from the provider regarding past service identifiers associated with the patient identifier, the past service identifiers related to the medical condition; and
computer readable instructions that enable the computer to respond with at least a portion of the patient's medical record, the medical record portion related to the medical condition and including clinical data related to the medical condition.

7. A computer program product according to claim 1, said program code further comprising:
computer readable instructions that enable the computer to receive an information request regarding provider identifiers related to the medical condition; and
computer readable instructions that enable the computer to respond with providers associated with the provider identifiers related to the medical condition, the providers categorized by role and by provider goal achievement.

8. A computer program product according to claim 1, said program code further comprising:
computer readable instructions that enable the computer to receive an information request regarding provider identifiers related to the medical condition; and
computer readable instructions that enable the computer to respond with unbounded virtual teams associated with the provider identifiers related to the medical condition and with patient goal achievement indicators associated with each unbounded virtual team.

9. An incentive system comprising:
a general purpose computer; and
one or more databases operatively connected to the general purpose computer;
the one or more databases including encounter records, clinical records, patient records, and provider records;
the general purpose computer programmed to;
receive at least a portion of a provider payment request, the provider payment request including a provider identifier, a patient identifier, medical codes, and clinical information, the clinical information and the medical codes related to a medical condition;
verify that the provider identifier is associated with a provider record;
verify that the patient identifier is associated with a patient record;
update an encounter record associated with the patient identifier with the provider identifier and the medical codes;
update a clinical record associated with the patient identifier with the clinical information; and
grant a provider associated with the provider identifier access to the patient record associated with the patient identifier, access to clinical records associated with the patient identifier and the medical condition, and access to encounter records associated with the patient identifier and the medical condition.

10. An incentive system according to claim 9, wherein the general purpose computer is further programmed to:
retrieve encounter records associated with the provider identifier and the medical condition, the encounter records including patient identifiers;
retrieve clinical records based on the patient identifiers retrieved from the encounter records;
determine a patient goal achievement indicator for each patient identifier retrieved from the encounter records based on the retrieved clinical records;
determine a provider goal achievement indicator based on the determined patient goal achievement indicators; and
determine a reward based on the provider goal achievement indicator.

11. A method for facilitating healthcare services comprising:
receiving at a computer at least a portion of an electronic provider payment request, the portion of the provider payment request including a provider identifier, a patient identifier, and a service identifier representing a current service rendered by the provider, the service identifier related to a medical condition;
identifying by the computer a patient record in a database, the patient record associated with the patient identifier;
identifying by the computer a provider record in a database, the provider record associated with the provider identifier;
associating by the computer the provider identifier with both the patient identifier and with the service identifier in a database to update a current unbounded virtual team associated with the patient identifier, the current unbounded virtual team including other providers with unique provider identifiers that are associated with the patient identifier and with a past service identifier related to the medical condition; and
granting information access to a medical record for the patient by the computer to the provider associated with the provider identifier, the medical record related to the medical condition and the medical record including clinical data from the other providers who are members of the current unbounded virtual team; and
accessing through the computer the medical record for the patient, and basing further treatment for the medical condition at least in part on the medical record.

12. A method for facilitating healthcare services comprising:
receiving at a computer at least a portion of an electronic provider payment request from a provider, the portion of the provider payment request relating to a current service rendered for a patient;
determining by the computer whether the request for payment should be paid;
determining by the computer whether the current service rendered qualifies the provider for a bonus;
creating by the computer a virtual unbounded team of healthcare providers, the team including healthcare providers who rendered past services for the patient within a predetermined period of time, and each rendered past service qualified the healthcare provider who rendered the past service for a bonus;
adding the provider to the virtual unbounded team by the computer based on whether the current service qualifies the provider for a bonus; and
granting access to medical records for the patient by the computer to each provider on the virtual unbounded team.

13. A method for facilitating healthcare services according to claim 12, wherein the current service is related to a medical condition, each past service is related to the medical condition, and the medical records are related to the medical condition.
